(19) United States
(12) Patent Application Publication
(10) Pub. No.: US 2010/0206697 A1
(43) Pub. Date: Aug. 19, 2010

(54) WALKING-BEAM CONVEYOR

(76) Inventors: Karl Robert HOFMANN, Netphen (DE); Bernd Buedenbender, Netphen (DE)

Correspondence Address: KF ROSS PC, 5683 RIVERDALE AVENUE, SUITE 203 BOX 900, BRONX, NY, 10471-0900, US

(21) Appl. No.: 12/697,396

(22) Filed: Feb. 1, 2010

(30) Foreign Application Priority Data
Feb. 14, 2009 (DE) 102009009097.5

(51) Int. Cl. B65G 25/02

(52) U.S. Cl. 198/775

(57) ABSTRACT

A walking-beam conveyor for stepped transport of heavy objects has an upstream beam extending in a horizontal transport direction and adapted to carry a plurality of the objects. A pair of horizontally spaced upstream supports underneath the upstream beam are associated with respective vertical and horizontal upstream drives for raising the upstream beam relative to the supports, shifting the upstream beam a step downstream, lowering the upstream beam, and shifting the upstream beam a step upstream to shift the objects on the upstream downstream in steps. In accordance with the invention a downstream beam immediately downstream of the upstream beam has an upstream end juxtaposed with a downstream end of the upstream beam with a single downstream support under the downstream beam. A pivot connects the downstream end of the upstream beam to the upstream end of the downstream beam for joint synchronous vertical and horizontal movement of the two beams.

### FIELD OF THE INVENTION

The present invention relates to a walking-beam conveyor. More particularly this invention concerns such a conveyor for the stepped transport of a succession of large objects.

### BACKGROUND OF THE INVENTION

A walking-beam conveyor for the stepped transport of strip coils or coils of sheet metal, sheet packets or similar transport objects has a beam that can be raised and lowered by lifters as well as displaced in the transport direction relative to at least one support rail by at least one travel drive. It also has two wheel assemblies or stools. The beam is typically coupled to a following walking-beam conveyor.

A walking-beam conveyor of this type has several beams of the same conveyor type arranged one behind the other in the transport direction and coupled to one another, as known from U.S. Pat. No. 6,650,963. The beams are moved jointly forward and backward in steps via their travel drives. The individual conveyors are coupled to one another by respective connecting rods. The beam or beams can thereby be raised and lowered by their lifters so that the sheet-metal coils bearing on lateral bearing surfaces can be moved in a steps or incrementally displaced along in the transport direction.

With a walking-beam conveyor known from DE 12 94 281, several beams arranged one after the other in the travel direction are connected to one another via couplings only transmitting the drive motion, otherwise permitting an optional raising or lowering independently of one another. The lifters assigned to each beam are arranged on a respective stool that is moved via support wheels on a rail arrangement in the transport direction or longitudinal direction. At least two stools, which have two drive axles, are provided for each beam.

Since each individual beam is designed for a specific number of coils with a specific geometry and thus for a fixed maximum weight, with the known walking-beam conveyors with an increase in the number of coils or with the transport of coils larger in diameter and heavier, several of these beams are coupled to one another. The beams with their frames are jointly moved via the suspension or the coupling on the lines of support rails in the transport direction, but can be raised and lowered independently of one another. The coupling of several completely independent beams for the stepped transport of an increased total load is hereby indispensable, since the individual components of a beam are coordinated with one another such that an increase in the number of coils or an increase in weight of the individual coils would lead to a complete reworking or adjustment of the individual beams.

An essential component of the beam is thus its frame. Usually two travel drives or stools with respective axles and wheels are installed for each beam. The stools are designed for a specific maximum axle load that must not be exceeded. An increase in the axial load by additional coils or heavier coils would hence require a change of the rail systems for the wheels in addition to a new construction of the frame.

### OBJECTS OF THE INVENTION

It is therefore an object of the present invention to provide an improved walking-beam conveyor.

Another object is the provision of such an improved walking-beam conveyor that overcomes the above-given disadvantages, in particular that can be variably expanded in a simple and cost-effective manner for the transport of a greater number of coils of sheet metal.

### SUMMARY OF THE INVENTION

A walking-beam conveyor for stepped transport of heavy objects has according to the invention an upstream beam extending in a horizontal transport direction and adapted to carry a plurality of the objects. A pair of horizontally spaced upstream supports underneath the upstream beam are associated with respective vertical and horizontal upstream drives for raising the upstream beam relative to the supports, shifting the upstream beam a step downstream, lowering the upstream beam, and shifting the upstream beam a step upstream to shift the objects on the upstream downstream in steps. In accordance with the invention a downstream beam immediately downstream of the upstream beam has an upstream end juxtaposed with a downstream end of the upstream beam with a single downstream support under the downstream beam. A pivot connects the downstream end of the upstream beam to the upstream end of the downstream beam for joint synchronous vertical and horizontal movement of the two beams.

Thus, in contrast to a second independent beam, the downstream beam does not perform any independent sequences of motions, but is synchronized with the sequences of motions of the upstream beam.

To transport the coils, beams can hereby be used which are different in their dimensions and their bearing capacity and constructed to be adapted to the transport tasks in a modular and variable manner, so that in particular from load and costs aspects, an optimum combination of upstream beams and downstream beam depending on the number of coils and the corresponding coil weight is always possible. The present or existing walking beam conveyor installations do not need to be altered or converted in any way, in particular a further complete beam with two stools is dispensable. Coupling the conveyor via a pivot or spherical plain bearing synchronizes the system despite the total of three stools or wheel assemblies.

A preferred embodiment of the invention provides that the downstream has its own vertical drive. This means that the downstream beam does not have its own drive for horizontal transport movement and is moved jointly with the upstream beam on which, for example, a horizontal cylinder acts. In contrast to the upstream beam, the downstream beam conveyor by itself would be passive. Through the pivot connection of the downstream beam or conveyor to the upstream beam, preferably by a simple bearing transferring horizontal as well as vertical forces, the downstream beam is passively synchronized despite the single support stool. In contrast, an elongated upstream beam with, for example, three stools would be passive. The lifter of the downstream beam can be embodied, for example, as a piston/cylinder unit or as an eccentric raising gear and synchronized with the raising and lowering movements of the upstream beam. For example, with an eccentric raising gear which is or are embodied in the stools, namely as the eccentric wheel containing the bearing of the wheels, through a coupling rod that connects the crank wheels to one another. For the vertical lift, a lift cylinder is hereby pivoted on the one hand at an off-center position of an eccentric wheel and on the other hand on the upstream beam or on the beam of the downstream beam.

The combination of walking-beam conveyor and conveyor with a single wheel assembly or stool and pivoted connection of the downstream beam thereby also actively does not require a cost-intensive second frame as would be the case with a complete beam or any other conversion measures for the conveyor system.

### BRIEF DESCRIPTION OF THE DRAWING

The above and other objects, features, and advantages will become more readily apparent from the following description, reference being made to the accompanying drawing in which:

FIG. 1 is a side view of a prior-art walking-beam conveyor for five objects; and

FIGS. 2-4 are systems according to the instant invention with different numbers of coils on the upstream and downstream conveyors.

### SPECIFIC DESCRIPTION

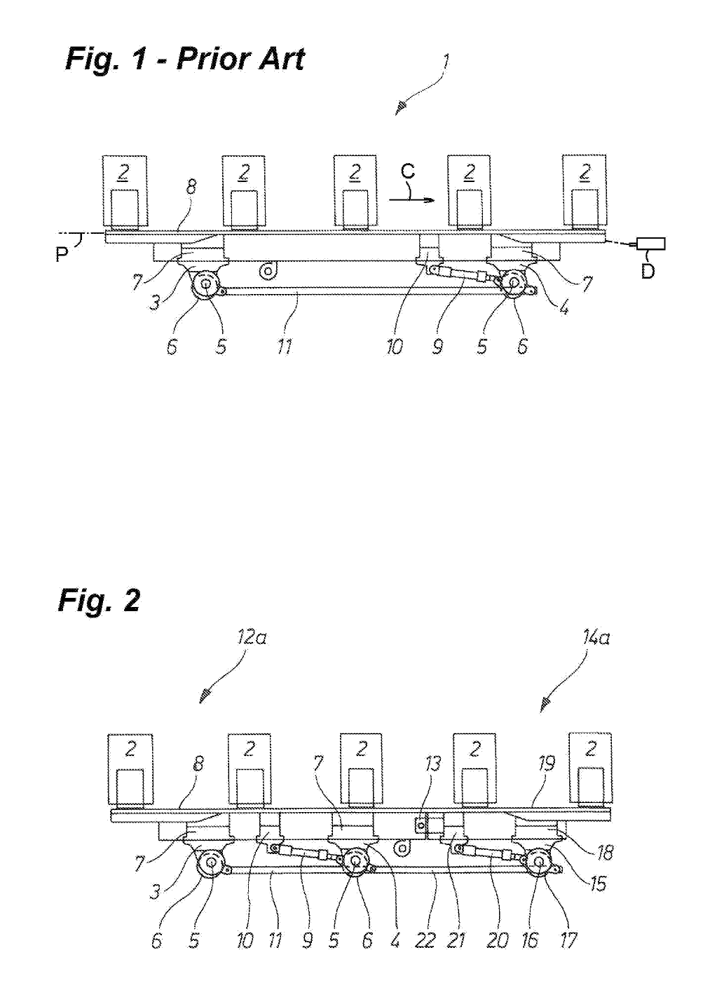

FIG. 1 shows a prior-art walking-beam conveyor 1 for the stepped transport of in this case five sheet-metal coils 2. This is a continuous conveyor that superimposes vertical and horizontal movements to move the coils 2 with a succession of identical steps.

The frame of the conveyor 1 is formed by two stools 3 and 4 each carried on a respective axle 5 journaled eccentrically in a respective wheel 6. The wheels 6 are guided with the horizontal movement or transport movement of the conveyor 1 on unillustrated guide rails of a rail system within the conveyor.

Each of the two stools 3 and 4 carries a respective lifter 7 that can raise and lower an upstream beam 8 carrying the coils 2 relative to a stationary support P or instead and thus optionally (Both variants being indicated at next to one another in the illustrated embodiment.) the vertical movement can be effected by eccentric lifters in each of the stools 3 and 4. To this end, the stool 4 has a lift cylinder 9, which on the one hand is pivoted off-center to an eccentric wheel carrying the pivot of the respective wheel 6, and on the other hand to a support 10 on the upstream beam 8. The eccentric wheels are coupled to one another via a connecting rod 11 for synchronous rotation. Extension of the lift cylinder 9 rotates the eccentric wheel to initiate vertical movement at the same time through the eccentric wheel bearing. The horizontal travel drive of the conveyor 1 is carried out, for example, by standard known cylinder drives or motor drives such as shown schematically at D. Stepped forward and backward motion and corresponding raising and lowering of the conveyor 1, moves the coils 2 carried on the upstream beam 8 in steps the desired conveyor direction C.

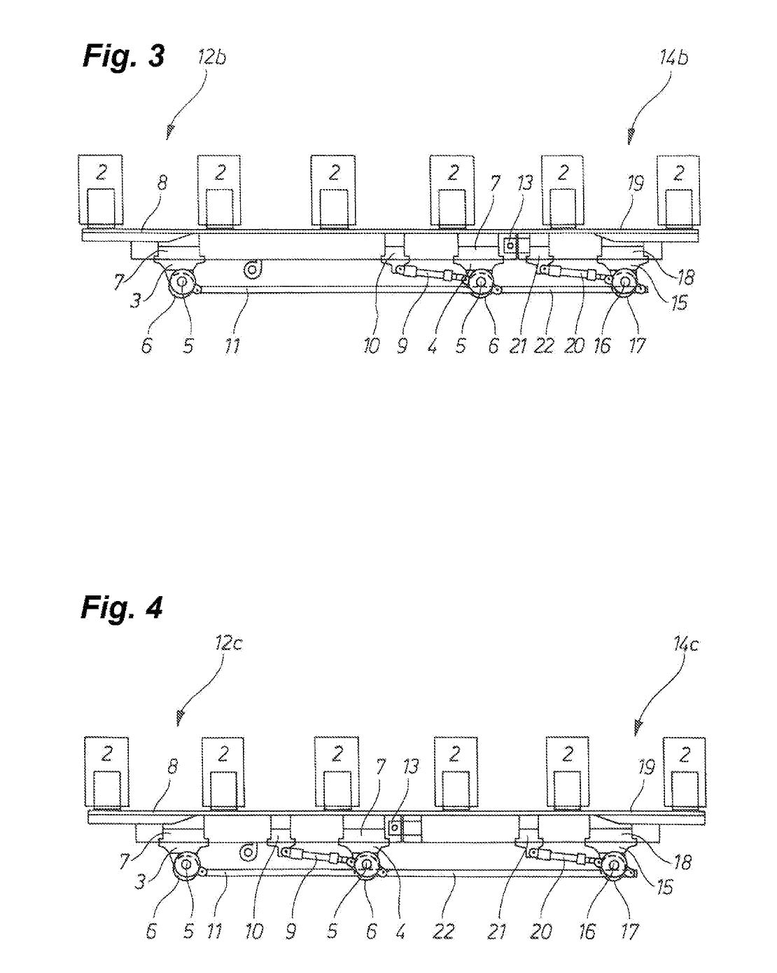

FIG. 2 shows a conveyor 12a of the same design as described above for the prior-art conveyor 1. A downstream beam or conveyor 14a is connected to the upstream conveyor 12a by a pivot 13 embodied as plain bearing. The downstream conveyor 14a has on its downstream end remote from the pivot 13 bearing only one stool or wheel assembly 15, i.e. an axle 16 with wheels 17 connected thereto. A lifter 18 for raising and lowering a downstream beam 19 bearing a coil 2 is provided above the stool 15. Here, too, an eccentric raising gear can optionally be provided, as already explained above for FIG. 1, to which end a cylinder 20 is provided on the stool 15 that for raising and lowering the downstream beam 19 is connected to a support 21 thereon.

The eccentric wheel of the raising gear of the downstream conveyor 14a is coupled via a link or connecting rod 22 to the connecting rod 11 of the upstream conveyor 12a for synchronous movement. This means that the downstream conveyor 14a does not perform any raising and lowering movements independently of the upstream conveyor 12a, but carries out exactly the same synchronous sequences of motions as the upstream conveyor 12a.

The advantage of the downstream conveyor 14a coupled by a simple pivot 13 to the upstream conveyor 12a is that, in contrast to a complete independent conveyor 1 or 12a when such a complete beam of this type were necessary as a second beam due to the load situation, only one stool 15 or one axle 16 is needed. The pivot connection to the upstream conveyor 12a, gives the downstream conveyor 14a the same solid positioning as the upstream conveyor 12a carried on two stools 3 and 4.

As can be seen from FIG. 2, for better weight distribution of the coils 2 that are heavier compared to FIG. 1, the five coils 2 to be transported in FIG. 1 by a conveyor 1 with the upstream conveyor 12a with the downstream conveyor 14a were divided in the ratio of three (upstream conveyor 12a) to two (downstream conveyor 14a).

In the embodiment according to FIG. 3, an upstream conveyor 12b is loaded with four coils 2 and a downstream conveyor 14b is loaded with two coils 2. The upstream conveyor 12b here has a greater length than the downstream conveyor 14b. With the upstream conveyor 12b, its maximum carrying capacity with respect to the number of coils as well as to maximum coil weight is reached by loading with four coils 2. In this case, for the stepped transport of additional coils 2 a downstream conveyor 14b is pivoted on its downstream. This downstream conveyor 14b is designed for conveying two coils 2.

With the upstream conveyor 12c with downstream conveyor 14c shown in FIG. 4, the upstream conveyor 12c has a shorter length than the downstream conveyor 14c. The construction-related carrying capacity of the upstream conveyor 12c is here reached by loading with three coils 2, so that to transport three further coils 2, the pivotally connected downstream conveyor 14c has greater length and is thus designed in terms of the frame as well in terms of raising technology for a higher load bearing.

As the embodiments according to FIGS. 2 through 4 show that the pivotal connection of downstream conveyors 14a, 14b, and 14c of different lengths and/or built for different load-bearing levels, creates a very variable conveyor system that can be installed very easily on existing conveyor tracks without conversion measures and in terms of load and cost aspects renders possible at any time an optimum combination of upstream and downstream beam depending on the coil weight and the number of coils or the transport task to be carried out.

We claim:

1. A walking-beam conveyor for stepped transport of heavy objects, the conveyor comprising:
an upstream beam extending in a horizontal transport direction and adapted to carry a plurality of the objects;
a pair of horizontally spaced upstream supports underneath the upstream beam;
respective vertical and horizontal upstream drive means for raising the upstream beam relative to the supports, shifting the upstream beam a step downstream, lowering the upstream beam, and shifting the upstream beam a step upstream to shift the objects on the upstream downstream in steps;
a downstream beam immediately downstream of the upstream beam and having an upstream end juxtaposed with a downstream end of the upstream beam;
a single downstream support under the downstream beam; and
a pivot connecting the downstream end of the upstream beam to the upstream end of the downstream beam for joint synchronous vertical and horizontal movement.

2. The walking-beam conveyor defined in claim 1, further comprising:
vertical downstream drive means for raising and lowering the downstream beam relative to the downstream support.

3. The walking-beam conveyor defined in claim 1 wherein the pivot transmits vertical and horizontal forces between the beams.

4. The walking-beam conveyor defined in claim 3 wherein the pivot defined a horizontal pivot axis generally perpendicular to the beams.

5. The walking-beam conveyor defined in claim 1 wherein the stools are each associated with a respective drive wheel.
